(19) United States
(12) Patent Application Publication
(10) Pub. No.: US 2010/0176763 A1
(43) Pub. Date: Jul. 15, 2010

(54) Battery balancing apparatus and operating method thereof

(75) Inventor: Wei-Ting Yen, Taipei City (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 12/453,691

(22) Filed: May 19, 2009

(30) Foreign Application Priority Data
Jan. 13, 2009 (TW) 098101064

(51) Int. Cl. H02J 7/00

(52) U.S. Cl. 320/118

(57) ABSTRACT

The invention provides a battery balancing apparatus. The battery balancing apparatus is applied to a battery module of a laptop computer. The battery module comprises a plurality of batteries and a plurality of switch units coupled in series. The battery balancing apparatus comprises a first multiplexer, a second multiplexer, a switch module and a controlling module. The first multiplexer is coupled to the anode of each of the batteries; the second multiplexer is coupled to the cathode of each of the batteries. The switch module is coupled to the switch units. When a cycle counting parameter meets a default condition, the controlling module controls the first multiplexer, the second multiplexer and the switch module to be in a specific mode to form a specific current path among the batteries.

### BACKGROUND OF THE INVENTION

1. Field of the Invention

The present invention relates generally to the batteries of a laptop computer, and more particularly, to a battery balancing apparatus and operating method thereof for equally using each of the batteries of the laptop computer to extend the lifetime of the batteries and improve the operating safety.

2. Description of the Prior Art

Along with the advance of technology recently, various kinds of computer facilities have been introduced to the market. Among numerous computer facilities, a laptop computer has become one of the most popular products on the market owing to the advantages such as a small size, light weight and portability, etc. Moreover, it is an indispensable tool to people's daily life.

Generally, a laptop computer could be mains powered or battery powered. Under the condition of battery powered, an operating battery voltage of a laptop computer ranges from 10.8V to 12.6V. However, a single lithium battery can apply only about 3.7V in general so that three or more lithium batteries coupled in series are commonly used to provide the operating voltage for laptop computers.

Please refer to FIG. 1. FIG. 1 illustrates a type of a conventional battery module of a laptop computer. As illustrated in FIG. 1, the battery module 1 comprises a first battery pair 11, a second battery pair 12 and a third battery pair 13, and three battery pairs are coupled in series. The first battery pair 11 comprises a first battery 111 and a second battery 112 coupled in parallel; the second battery pair 12 comprises a third battery 121 and a fourth battery 122 coupled in parallel; the third battery pair 13 comprises a fifth battery 131 and a sixth battery 132 coupled in parallel. Namely, each of the battery pairs coupled in series comprises two batteries coupled in parallel, so the battery module 1 could be named a battery module of “three in series and two in parallel”.

FIG. 2 illustrates another type of a conventional battery module of a laptop computer. As illustrated in FIG. 2, the battery module 2 comprises a first battery 21, a second battery 22 and a third battery 23, and three batteries are coupled in series.

However, for the battery module 1 in FIG. 1 or the battery module 2 in FIG. 2, the charging/discharging current path among the batteries coupled in series is always the same. Thus, when the battery module is charging or discharging, the battery (or the battery pair) arranged in the front, such as the first battery pair 11 in FIG. 1 and the first battery 21 in FIG. 2, is always the first one that the charging/discharging current flows through.

As the increase of the operation time of a laptop computer, the temperature of the battery (or the battery pair) arranged in the front is usually higher than that of others, which results in a shorter lifetime of the battery arranged in the front. Moreover, the battery module of the laptop computer could be in a dangerous situation such as leaking or venting.

Accordingly, the main aspect of the present invention is to provide a battery balancing apparatus and an operating method thereof to solve the problem mentioned above.

### SUMMARY OF THE INVENTION

The main aspect of the present invention is to provide a battery balancing apparatus for equally using each of the batteries of the laptop computer to extend the lifetime of the batteries and improve the operating safety.

An embodiment of the invention is a battery balancing apparatus. The battery balancing apparatus is applied to a battery module of a laptop computer. The battery module comprises a plurality of batteries and a plurality of switch units coupled in series. In the embodiment, the battery balancing apparatus comprises a first multiplexer, a second multiplexer, a switch module and a controlling module. The first multiplexer is coupled to the anode of each of the batteries; the second multiplexer is coupled to the cathode of each of the batteries. The switch module is coupled to the switch units for controlling each of the switch units to be in the state of On or Off.

When a cycle counting parameter meets a default condition, the controlling module selects a corresponding specific mode from a plurality of default modes to generate a switching signal. The switching signal is for controlling the first multiplexer, the second multiplexer and the switch module to be in a specific mode, for forming a specific current path among the batteries. In the specific current path, a charging/discharging current flows through the batteries in a specific sequence corresponding to the specific mode.

Another embodiment of the invention is a method for operating a battery balancing apparatus. The battery balancing apparatus is applied to a battery module of a laptop computer. The battery module comprises a plurality of batteries and a plurality of switch units coupled in series. The battery balancing apparatus comprises a first multiplexer, a second multiplexer and a switch module. The first multiplexer is coupled to the anode of each of the batteries, the second multiplexer is coupled to the cathode of each of the batteries, and the switch module is coupled to the switch units.

In the embodiment, the method is to judge if the cycle counting parameter meets a default condition when the battery balancing apparatus receives a cycle counting parameter. If the judgment in the method is yes, a corresponding specific mode is then selected from a plurality of default modes. Subsequently, the first multiplexer, the second multiplexer and the switch module are controlled in the method to be in the specific mode to form a specific current path among the batteries. In the specific current path, a charging/discharging current flows through the batteries in a specific sequence corresponding to the specific mode.

To summarize, the battery balancing apparatus and the operating method thereof are to make use of the original cycle counting parameter generated by the cycle counter of the battery management unit of a laptop computer, and collocate with two multiplexers and the switch module to cyclically switch the current path where the charging/discharging current of the laptop computer flow along, so as to effectively extend the service life of the batteries of a laptop computer and improve the operating safety as well.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 illustrates a type of a conventional battery module of a laptop computer according to the prior art.

FIG. 2 illustrates another type of a conventional battery module of a laptop computer according to the prior art.

FIG. 3 is a functional block diagram illustrating a battery balancing apparatus according to a first embodiment of the invention.

FIG. 4 illustrates an example which a battery balancing apparatus is applied to the battery module of a laptop computer.

FIG. 5 is a timing looking-up table used in the example in FIG. 4.

FIG. 6 is a flow chart illustrating a method for operating a battery balancing apparatus according to a second embodiment of the invention.

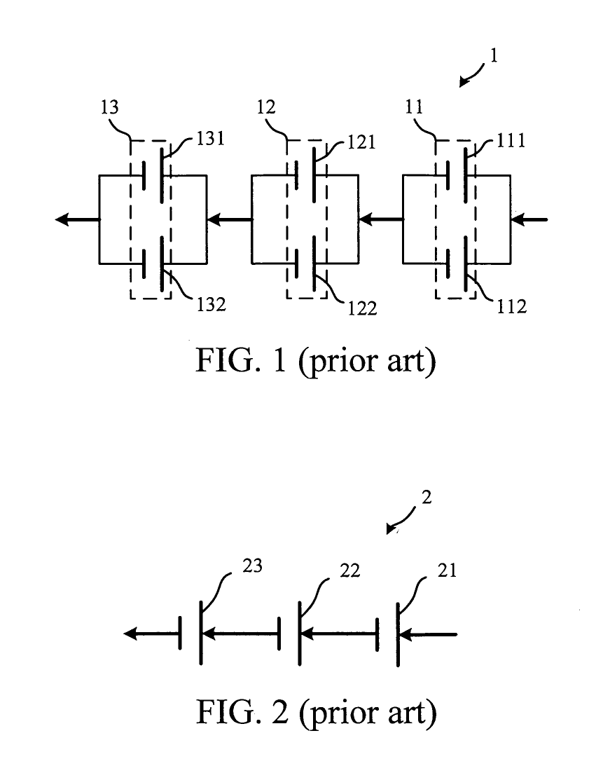

### DETAILED DESCRIPTION OF THE INVENTION

A first embodiment of the invention is a battery balancing apparatus. In the embodiment, the battery balancing apparatus is applied to a battery module of a laptop computer. The battery module comprises a plurality of batteries and a plurality of switch units coupled in series, wherein the plurality of batteries and the plurality of switch units are interlaced and coupled in series. Namely, there is a battery between two switch units and series connected to the two switch units, and there is a switch unit between two batteries and series connected to the two batteries. Generally, the plurality of batteries is, but not limited to, lithium batteries. As mentioned in the prior art, a single lithium battery can only provide a voltage of 3.7V in general, so three (or more) lithium batteries are coupled in series to provide the operation voltage of a laptop computer.

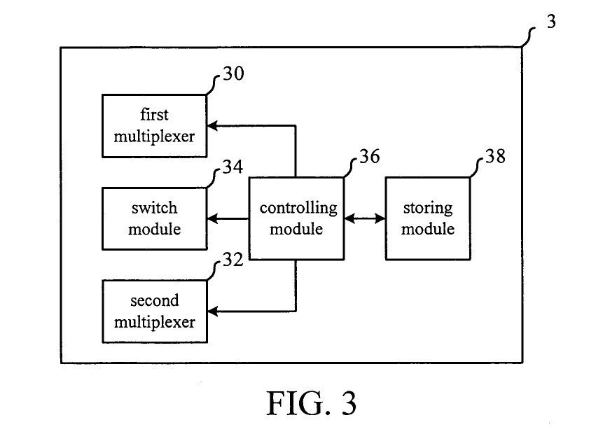

Please refer to FIG. 3. FIG. 3 is a functional block diagram illustrating the battery balancing apparatus. As illustrated in FIG. 3, the battery balancing apparatus 3 comprises a first multiplexer 30, a second multiplexer 32, a switch module 34, a controlling module 36 and a storing module 38. The first multiplexer 30 is coupled to the anode of each of the batteries; the second multiplexer 32 is coupled to the cathode of each of the batteries; the switch module 34 is coupled to the switch units of the battery module of the laptop computer; and the controlling module 36 is coupled to the first multiplexer 30, the second multiplexer 32, the switch module 34 and the storing module 38. Practically, the first multiplexer 30 is a one-to-many type multiplexer and the second multiplexer 32 is a many-to-one type multiplexer.

In the embodiment, the main function of the switch module 34 is to selectively control each of the switch units to be in the state of On or Off according to the instruction of the controlling module 36. The controlling module 36 selects a corresponding specific mode from a plurality of default modes to generate a switching signal when the controlling module 36 receives a cycle counting parameter which meets a default condition. The storing module 38 is for storing a timing looking-up table, wherein the timing looking-up table comprises the default modes, and the default modes are in a specific sequence in the timing looking-up table. The controlling module 36 selects a corresponding specific mode in turn from the default modes in the timing looking-up table according to the specific sequence.

Practically, the cycle counting parameter is fetched from a cycle counter of a battery management unit of the laptop computer. Namely, the cycle counting parameter is an original parameter in the laptop computer so that the original parameter is put into use by means of the controlling module 36 of the battery balancing apparatus 3 of the invention and any extra operation or process are not required.

Moreover, the default condition mentioned above means that the cycle counting parameter could be a multiple of M, wherein M is a positive integer. The default condition could be a default value or set by users. For instance, the default value of M is 5 and the cycle counting parameter starts counting from 1. Once the cycle counting parameter reaches a multiple of 5 (e.g. 5, 10, 15, etc), the cycle counting parameter is regarded as meeting the default condition. At this time, the controlling module 36 selects the corresponding specific mode from the default modes according to a specific sequence in the timing looking-up table, and generates a switching signal according to the specific mode.

After generating the switching signal, the controlling module 36 transmits the switching signal to the first multiplexer 30, the second multiplexer 32 and the switch module 34. In the embodiment, the switching signal is for controlling the first multiplexer 30, the second multiplexer 32 and the switch module 34 to be in a specific mode to form a specific current path among the batteries.

When the first multiplexer 30, the second multiplexer 32 and the switch module 34 are in a specific mode, the switch module 34 will selectively turn on or turn off the switch units, the first multiplexer 30 will selectively conduct one of the anodes of the batteries, and the second multiplexer 32 will selectively conduct one of the cathodes of the batteries, which forms the specific current path. When the battery module of the laptop computer is charging or discharging, in the specific current path, the charging/discharging current will flow through the batteries in a specific sequence corresponding to the specific mode.

Please note that different default modes are corresponding to different battery sequences. In order to reach the purpose of the invention that the batteries are all equally used, the battery arranged in the front in every charging/discharging path is different in every battery sequence. Namely, every battery will be located in the front in a specific battery sequence to avoid the disadvantages in the prior art.

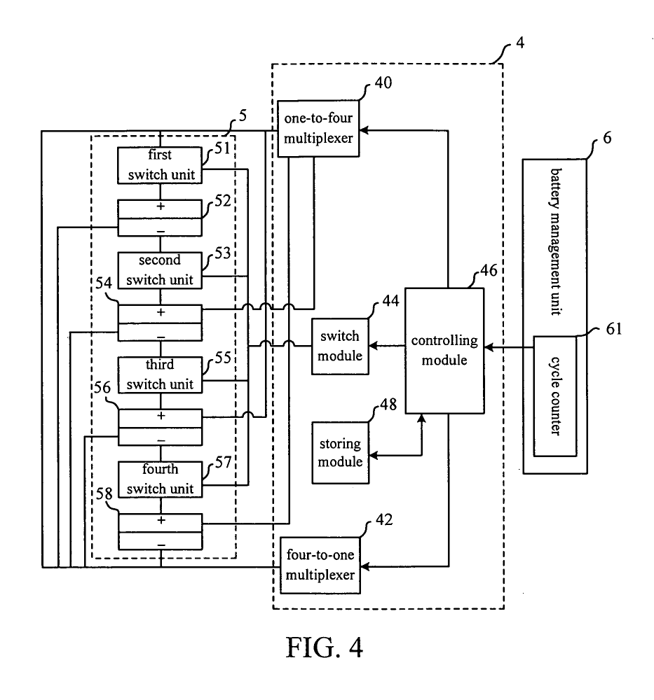

Subsequently, the concrete details are described in the following by means of a battery balancing apparatus practically applied to a laptop computer. Please refer to FIG. 4. FIG. 4 illustrates an example which a battery balancing apparatus is applied to the battery module of a laptop computer.

As illustrated in FIG. 4, the laptop computer is supposed to comprise four lithium batteries—a first battery 52, a second battery 54, a third battery 56 and a fourth battery 58, and four switch units—a first switch unit 51, a second switch unit 53, a third switch unit 55 and a fourth switch unit 57. The anode of the first battery 52 is coupled to the first switch unit 51 and the cathode of the first battery 52 is coupled to the second switch unit 53; the anode of the second battery 54 is coupled to the second switch unit 53 and the cathode of the second battery 54 is coupled to the third switch unit 55; the anode of the third battery 56 is coupled to the third switch unit 55 and the cathode of the third battery 56 is coupled to the fourth switch unit 57; and the anode of the fourth battery 58 is coupled to the fourth switch unit 57.

The battery balancing apparatus 4 comprises a one-to-four type multiplexer 40, a four-to-one type multiplexer 42, a switch module 44, a controlling module 46 and a storing module 48. The switch module 44 is coupled to the first switch unit 51, the second switch unit 53, the third switch unit 55 and the fourth switch unit 57, for controlling the four switch units to be in the state of On or Off; the one-to-four type multiplexer 40 is couple to the first switch unit 51, the anode of the second battery 54, the anode of the third battery 56 and the anode of the fourth battery 58; the four-to-one type multiplexer 42 is couple to the cathode of the first battery 52, the cathode of the second battery 54, the cathode of the third battery 56 and the cathode of the fourth battery 58.

Please note that in addition to the one-to-four type multiplexer 40, the four-to-one type multiplexer 42 and the switch module 44, the controlling module 46 is also coupled to a cycle counter 61 of a battery management unit 6 of the laptop computer. Thus, the controlling module 46 is capable of reading a cycle counting parameter from the cycle counter 61 to process the following cyclic switching movement according to the cycle counting parameter.

In the embodiment, it is assumed that the charging/discharging current of the laptop computer would flow through the four batteries by a first sequence (the first battery 52, the second battery 54, the third battery 56 and the fourth battery 58); namely, the controlling module 46 will control the one-to-four multiplexer 40, the four-to-one type multiplexer 42 and the switch module 44 to be in a first mode. Meanwhile, the switch module 44 will turn off the first switch unit 51, the second switch unit 53, the third switch unit 55 and the fourth switch unit 57 to allow the electric conduction among all of the batteries. The one-to-four multiplexer 40 will conduct the anode of the first battery 52 via the first switch unit 51, and the four-to-one type multiplexer 42 will conduct the cathode of the fourth battery 58, to form the first current path which meets the first sequence.

Assume that the default condition is set as the cycle counting parameter, and the parameter is a multiple of 5. Thus, the controlling module 46 will not generate any switching signal when the cycle counting parameter received by the controlling module 46 is one to four, which doesn't meet the default condition. At this time, the one-to-four multiplexer 40, the four-to-one type multiplexer 42 and the switch module 44 are still in the original first mode, so the charging/discharging current still flows through the four batteries along the first current path which meets the first sequence.

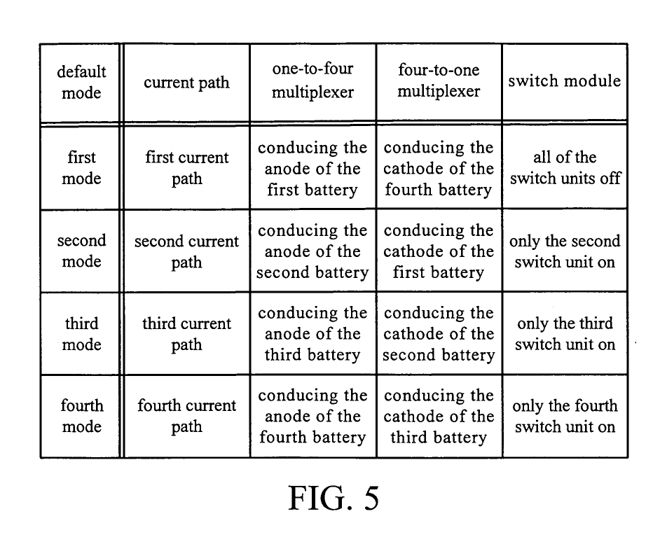

When the cycle counting parameter received by the controlling module 46 is exactly 5, the controlling module 46 will retrieve the timing looking-up table (as illustrated in FIG. 5) stored in the storing module 48, and select a second mode arranged after the first mode from the four default modes stored in the timing looking-up table. When the controlling module 46 controls the one-to-four multiplexer 40, the four-to-one type multiplexer 42 and the switch module 44 to be in the second mode, the switch module 44 will turn on the second switch unit 53 and keep the first switch unit 51, the third switch unit 55 and the fourth switch unit 57 off to make the circuit between the first battery 52 and the second battery 54 broken; besides, the one-to-four multiplexer 40 will conduct the anode of the second battery 54, and the four-to-one type multiplexer 42 will conduct the cathode of the first battery 52, to form the second current path which meets the second sequence (the second battery 54, the third battery 56, the fourth battery 58 and the first battery 52).

Similarly, when the cycle counting parameter received by the controlling module 46 is 10, the controlling module 46 will retrieve the timing looking-up table and select a third mode arranged after the second mode from the four default modes stored in the timing looking-up table. When the controlling module 46 controls the one-to-four multiplexer 40, the four-to-one type multiplexer 42 and the switch module 44 to be in the third mode, the switch module 44 will turn on the third switch unit 55 and keep the first switch unit 51, the second switch unit 53 and the fourth switch unit 57 off to make the circuit between the second battery 54 and the third battery 56 broken; besides, the one-to-four multiplexer 40 will conduct the anode of the third battery 56 and the four-to-one type multiplexer 42 will conduct the cathode of the second battery 54 to form the third current path which meets the third sequence (the third battery 56, the fourth battery 58, the first battery 52 and the second battery 54).

Likewise, when the cycle counting parameter received by the controlling module 46 is 15, the controlling module 46 will retrieve the timing looking-up table and select a fourth mode arranged after the third mode from the four default modes stored in the timing looking-up table. When the controlling module 46 controls the one-to-four multiplexer 40, the four-to-one type multiplexer 42 and the switch module 44 to be in the fourth mode, the switch module 44 will turn on the fourth switch unit 57 and keep the first switch unit 51, the second switch unit 53 and the third switch unit 55 off to make the circuit between the third battery 56 and the fourth battery 58 broken; besides, the one-to-four multiplexer 40 will conduct the anode of the fourth battery 58 and the four-to-one type multiplexer 42 will conduct the cathode of the third battery 56 to form the fourth current path which meets the fourth sequence (the fourth battery 58, the first battery 52, the second battery 54 and the third battery 56).

Subsequently, when the cycle counting parameter received by the controlling module 46 is 20, the controlling module 46 will control the one-to-four multiplexer 40, the four-to-one type multiplexer 42 and the switch module 44 to be in the original first mode again; namely, the charging/discharging current will flow through the four batteries along the first current path in the first sequence (the first battery 52, the second battery 54, the third battery 56 and the fourth battery 58). As the increase of the cycle counting parameter, the controlling module 46 will cyclically control the one-to-four multiplexer 40, the four-to-one type multiplexer 42 and the switch module 44 to be cyclically switched from the first mode to the fourth mode, and the purpose of equally using each of the batteries of the battery module 5 of the laptop computer is thus achieved.

The second embodiment of the invention is a method for operating a battery balancing apparatus. In the embodiment, the battery balancing apparatus is applied to a battery module of a laptop computer; the battery module comprises a plurality of batteries and a plurality of switch units coupled in series, wherein the plurality of batteries and the plurality of switch units are interlaced and coupled in series. Namely, there is a battery between two switch units and series connected to the two switch units, and there is a switch unit between two batteries and series connected to the two batteries. Generally, the plurality of batteries is, but not limited to, lithium batteries. As mentioned in the prior art, a single lithium battery can only provide a voltage of 3.7V so that three (or more) lithium batteries are coupled in series to provide the operation voltage of a laptop computer.

In the embodiment, the battery balancing apparatus comprises a first multiplexer, a second multiplexer and a switch module. The first multiplexer is coupled to the anode of each of the batteries and the second multiplexer is coupled to the cathode of each of the batteries. The switch module is coupled to the switch units. Practically, the first multiplexer is a one-to-many type multiplexer and the second multiplexer is a many-to-one type multiplexer.

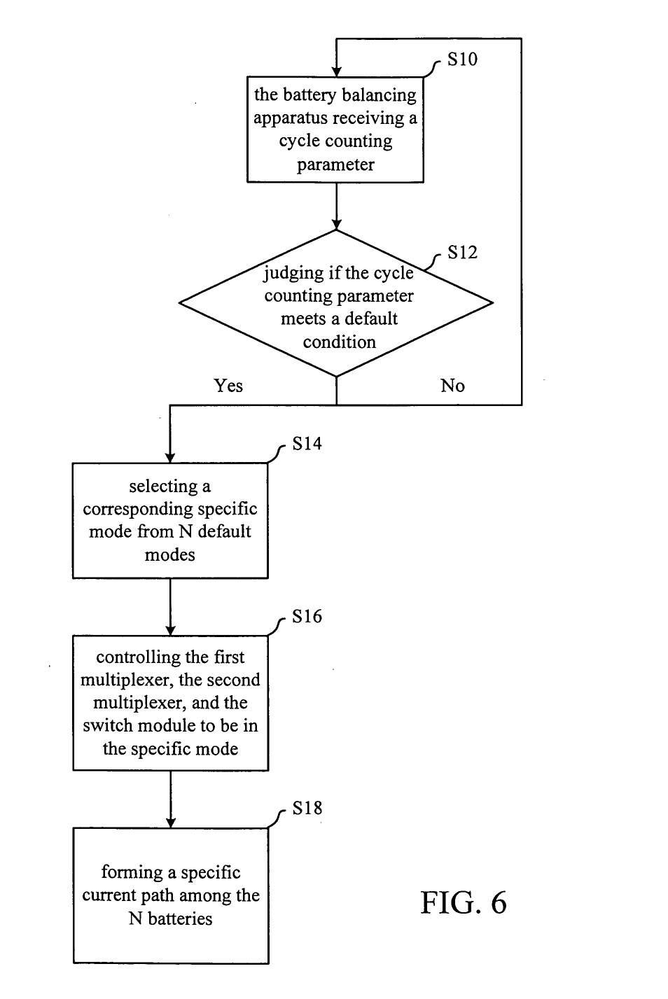

Please refer to FIG. 6. FIG. 6 is a flow chart illustrating the method for operating the battery balancing apparatus. As illustrated in FIG. 6, a cycle counting parameter is received by the battery balancing apparatus in step S10. Practically, the cycle counting parameter is fetched from a cycle counter of a battery management unit of the laptop computer. Namely, the cycle counting parameter is an original parameter in the laptop computer, so the method of the invention is to put the original parameter into use and does not require any extra operation or process.

After that, step S12 is performed to judge if the cycle counting parameter meets a default condition. Practically, the default condition could be that the cycle counting parameter and the parameter is a multiple of M, wherein M is a positive integer. The default condition could be, but not limited to, a default value or set by users. For example, the default value of M is 10 and the cycle counting parameter is counted from 1. Once the cycle counting parameter is exactly a multiple of 10 (e.g. 10, 20, 30, etc), then the cycle counting parameter is regarded as meeting the default condition.

If the judgment in step S12 is yes, step S14 is then performed to select a corresponding specific mode from a plurality of default modes. Particularly, the method is to select a corresponding mode in turn from the plurality of default modes according to the default modes in a specific sequence in the timing looking-up table. If the judgment in step S12 is no, it means that the cycle counting parameter doesn't meet the default condition. Therefore, the method will return back to step S10, and the battery balancing apparatus will continuously receive the cycle counting parameter which is counting.

Subsequently, step S16 is performed to control the first multiplexer, the second multiplexer, and the switch module to be in the specific mode. And a specific current path among the batteries is formed in step S18. When the first multiplexer, the second multiplexer, and the switch module are in the specific mode, the first multiplexer will selectively conduct one of the anodes of the batteries, and the second multiplexer will selectively conduct one of the cathodes of the batteries, which forms the specific current path. When the battery module of the laptop computer is charging or discharging, the charging/discharging current will flow through the batteries in a specific sequence corresponding to the specific mode.

Please note that different default modes are corresponding to different battery sequences. In order to reach the purpose of the invention that the batteries are equally used, the battery arranged in the front in every charging/discharging path is different in every battery sequence. Namely, every battery will be located in the front in a specific sequence to avoid the disadvantages in the prior art.

To summarize, compared to prior art, the battery balancing apparatus and the operating method thereof are to make use of the original cycle counting parameter generated by the cycle counter of the battery management unit of a laptop computer, and collocate with two multiplexers and the switch module to cyclically switch the current path where the charging/discharging current of the laptop computer flow along, so as to effectively extend the service life of the batteries of a laptop computer and improve the operating safety as well.

Although the present invention has been illustrated and described with reference to the preferred embodiment thereof, it should be understood that it is in no way limited to the details of such embodiment but is capable of numerous modifications within the scope of the appended claims.

What is claimed is:

1. A battery balancing apparatus applied to a battery module of a laptop computer, the battery module comprising a plurality of batteries and a plurality of switch units coupled in series, the battery balancing apparatus comprising:
a first multiplexer coupled to the anode of each of the batteries;
a second multiplexer coupled to the cathode of each of the batteries:
a switch module, coupled to the switch units, for controlling each of the switch units on or off; and
a controlling module coupled to the first multiplexer, the second multiplexer, and the switch module; the controlling module selecting a corresponding specific mode from a plurality of default modes to generate a switching signal when a cycle counting parameter received by the controlling module meets a default condition;
wherein the switching signal is for controlling the first multiplexer, the second multiplexer and the switch module to be in the specific mode to form a specific current path among the batteries.

2. The battery balancing apparatus of claim 1, wherein in the specific current path, a charging/discharging current flows through the batteries in a specific sequence corresponding to the specific mode.

3. The battery balancing apparatus of claim 1, wherein in the specific mode, the switch module selectively switches on or off the switch units, the first multiplexer selectively conducts one of the anodes of the batteries, and the second multiplexer selectively conducts one of the cathodes of the batteries, to form the specific current path.

4. The battery balancing apparatus of claim 1, wherein the cycle counting parameter is fetched from a cycle counter of a battery management unit of the laptop computer.

5. The battery balancing apparatus of claim 1, wherein the first multiplexer is a one-to-many type multiplexer.

6. The battery balancing apparatus of claim 1, wherein the second multiplexer is a many-to-one type multiplexer.

7. The battery balancing apparatus of claim 1, wherein the default condition is that the cycle counting parameter is a multiple of M, and M is a positive integer.

8. The battery balancing apparatus of claim 1, wherein the default condition is capable of being a default value or set by users.

9. The battery balancing apparatus of claim 1 further comprising:
a storing module, coupled to the controlling module, for storing a timing looking-up table, wherein the timing looking-up table comprises the default modes, the default modes is in a specific sequence in the timing looking-up table.

10. The battery balancing apparatus of claim 9, wherein the controlling module selects the corresponding specific mode from the default modes according to the specific sequence.

11. A method of operating a battery balancing apparatus, the battery balancing apparatus being applied to a battery module of a laptop computer, the battery module comprising a plurality of batteries and a plurality of switch units coupled in series, the battery balancing apparatus comprising a first multiplexer, a second multiplexer and a switch module, the first multiplexer being coupled to the anode of each of the batteries and the second multiplexer being coupled to the cathode of each of the batteries, the switch module being coupled to the switch units, the method comprising the following steps:
(a) judging if the cycle counting parameter meets a default condition when the battery balancing apparatus receives a cycle counting parameter;
(b) if the judgment in step (a) is yes, selecting a corresponding specific mode from a plurality of default modes;
(c) controlling the first multiplexer, the second multiplexer, and the switch module to be in the specific mode to form a specific current path among the batteries;

12. The method of claim 11, wherein in the specific current path, a charging/discharging current flows through the batteries in a specific sequence corresponding to the specific mode.

13. The method of claim 11, wherein in the specific mode, the switch module selectively switches on or off the switch units, the first multiplexer selectively conducts one of the anodes of the plurality of batteries, and the second multiplexer selectively conducts one of the cathodes of the batteries, to form the specific current path.

14. The method of claim 11, wherein the cycle counting parameter is fetched from a cycle counter of a battery management unit of the laptop computer.

15. The method of claim 11, wherein the default condition is that the cycle counting parameter is a multiple of M, and M is a positive integer.

16. A method of claim 11, wherein the default condition is capable of a default value or set by users.
